(19) United States
(12) Patent Application Publication
(10) Pub. No.: US 2017/0039315 A1
(43) Pub. Date: Feb. 9, 2017

(54) INFORMATION PROCESSING APPARATUS AND SIMULATION METHOD

(71) Applicants: FUJITSU LIMITED, Kawasaki-shi (JP); University of Tsukuba, Tsukuba-shi (JP)

(72) Inventors: Tomotake NAKAMURA, Numazu (JP); Ryuhei HARADA, lbaraki (JP); Yasuteru SHIGETA, lbaraki (JP)

(73) Assignees: FUJITSU LIMITED, Kawasaki-shi (JP); University of Tsukuba, Tsukuba-shi (JP)

(21) Appl. No.: 15/228,540

(22) Filed: Aug. 4, 2016

(30) Foreign Application Priority Data
Aug. 7, 2015 (JP) 2015-156702

(51) Int. Cl. G06F 19/16; G06F 17/18

(52) U.S. Cl. CPC G06F 19/16; G06F 17/18

(57) ABSTRACT

A storage unit stores therein a collection of structures of biomolecules whose structure varies. A computing unit decreases a temperature set as a temperature parameter, which represents the temperature of the biomolecules, from a prescribed value in steps. When decreasing the temperature of the temperature parameter, the computing unit performs clustering on the structures included in the collection from before the decrease, detects detect outlier structures from the clustering result, and performs molecular dynamics simulations using the temperature parameter with the outlier structures as initial structures. Then, the computing unit stores structures generated by the molecular dynamics simulations in the storage unit.

### CROSS-REFERENCE TO RELATED APPLICATION

This application is based upon and claims the benefit of priority of the prior Japanese Patent Application No. 2015-156702, filed on Aug. 7, 2015, the entire contents of which are incorporated herein by reference.

### FIELD

The embodiments discussed herein relate to an information processing apparatus and a simulation method.

### BACKGROUND

Computer simulations are used for predicting the native structure of biomolecules, such as a protein. For example, Molecular Dynamics (MD) simulations may be used to perform a structure search for a protein, thereby predicting its native structure. A variety of methods have been proposed for the protein structure search using the MD simulations. For example, there has been proposed a computational method called OFLOOD for detecting outliers, which rarely occur in the state distribution of a protein, and preferentially performing a structure search using the outliers, so as to predict the native structure efficiently.

In OFLOOD, the states represented by the time-sequence data (trajectories) of atomic coordinates generated by the MD simulations are classified (i.e., clustering is performed) in order to investigate the state distribution of a protein. A trajectory is a collection of atomic coordinates of a protein along time, which vary from time to time. In OFLOOD, protein structures that are not classified into any stable structure (cluster) among the protein structures included in trajectories are detected as outliers. Then, in OFLOOD, short-time MD simulations are carried out on the outliers again. The short-time MD simulations using the outliers as initial structures are able to achieve an efficient protein structure search.

In this connection, a clustering algorithm called FlexDice is used for the clustering performed in OFLOOD. FlexDice groups, in real-time, data elements in dense areas divided by sparse areas in a high-dimensional data space.

In addition, as a computational technique for predicting the native structures of proteins, there is a Simulated Annealing (SA) based on Monte Carlo simulation or MD simulation. SA mimics, on a computer, an “annealing” process of heating metal into a high-temperature liquid and then cooling it gradually to thereby produce an ordered crystal structure that keeps the minimum energy state. SA begins at a high-temperature state, randomly generates a new structure as a solution in the vicinity of the current state, and if the new structure is stable in terms of energy, compared with the current state, selects the structure as a solution unconditionally. If the new structure is not stable in terms of energy, compared with the current state, SA determines whether to select the structure as a solution under probabilistic conditions. In general, a parameter T representing temperature is used in obtaining an optimal solution. As the T value is greater, a solution is searched for from a wider range. The T value is gradually decreased (slow cooling), and when the T value is sufficiently low, a solution that is stable in terms of energy (the native structure of a protein) is obtained. In this way, SA uses a probabilistic approach in execution of a local search method. Therefore, in the case where SA is employed for a protein native structure search, an effect of preventing convergence of generated protein structures to a local optimal solution (metastable structure) is expected.

As another method, there has been considered a prediction computational method that is able to predict the native structures of proteins with a simple computational procedure and highly precise prediction accuracy, compared with conventional methods. Furthermore, there has been considered another technique that automatically sets and updates an interaction range to thereby predict a structure of a protein similar to the native structure in a shorter time, without depending on the skills of an engineer who runs a program.

Please see Japanese Laid-open Patent Publication Nos. 7-105236 and 7-152775, and the following references:

Ryuhei Harada, Tomotake Nakamura, Yu Takano, and Yasuteru Shigeta, “Protein Folding Pathways Extracted by OFLOOD: Outlier FLOODing Method” Journal of Computational Chemistry, Jan. 15, 2015, Volume 36, Issue 2, pages 97-102;

Tomotake NAKAMURA, Yoko KAMIDOI, Shin-ichi WAKABAYASHI, Noriyoshi YOSHIDA, “FlexDice: A Fast Clustering Method for Large High Dimensional Data Sets”, Journal of Information Processing, Database, Vol. 46, No. SIG 18, pp. 40-49, December 2005; and

S. Kirkpatrick, C. D. Gelatt, M. P. Vecchi, “Optimization by Simulated Annealing”, Science, May 13, 1983, Vol. 220, No. 4598. pp. 671-680.

Conventionally, in the case of employing SA to predict the native structure of a protein, SA traces the structure of the protein, starting with an initial structure, to thereby predict the most stable structure (native structure). At this time, the temperature is decreased slowly at a speed falling within a feasible range, according to the capability of a computer. In this case, even SA is employed, protein structures generated with feasible short-time MD simulations are unable to escape from local optimal solutions (metastable state), and an optimal solution (native structure) may not be found. By decreasing the temperature very slowly in SA, it may be possible to reduce a possibility of converging such generated protein structures to the local optimal solution. This case, however, needs a massive amount of computation and is therefore not realistic.

This computational amount problem in the structure search also arises in an optimal solution prediction for not only proteins but also materials whose structures vary (for example, biomolecules other than proteins and metal crystals).

### SUMMARY

According to one aspect, there is provided an information processing apparatus including: a memory configured to store a collection of structures of biomolecules whose structure varies; and a processor configured to perform a procedure including: decreasing a temperature set as a temperature parameter from a prescribed value in steps, the temperature parameter representing a temperature of the biomolecules; performing, upon decreasing the temperature of the temperature parameter, clustering on the structures included in the collection from before the decreasing of the temperature, detecting an outlier structure from a result of the clustering, and performing a molecule dynamics simulation using the temperature parameter with the outlier structure as an initial structure; and including a structure generated by the molecule dynamics simulation in the collection.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of an information processing apparatus according to a first embodiment;

FIG. 2 illustrates an exemplary hardware configuration of a computer according to a second embodiment;

FIG. 3 is a functional block diagram for protein native structure prediction simulations;

FIG. 4 illustrates an example of a trajectory;

FIG. 5 illustrates an example of structure data of a protein;

FIG. 6 illustrates an example of energy information;

FIG. 7 illustrates an example of a clustering algorithm FlexDice;

FIG. 8 illustrates an example of a protein native structure prediction process;

FIG. 9 is a flowchart depicting an example of a protein structure analysis simulation;

FIG. 10 is a conceptual diagram depicting a difference between protein structure search processes with and without OFLOOD;

FIG. 11 illustrates an example of a test calculation of an artificial protein Trp-cage by SA without OFLOOD; and

FIG. 12 illustrates an example of a test calculation of an artificial protein Trp-cage by SA with OFLOOD.

### DESCRIPTION OF EMBODIMENTS

Several embodiments will be described below with reference to the accompanying drawings, wherein like reference numerals refer to like elements throughout. Features of the embodiments may be combined unless they exclude each other.

### First Embodiment

First, a first embodiment will be described. The first embodiment relates to an information processing apparatus 10 for predicting the native structure of biomolecules whose structure varies.

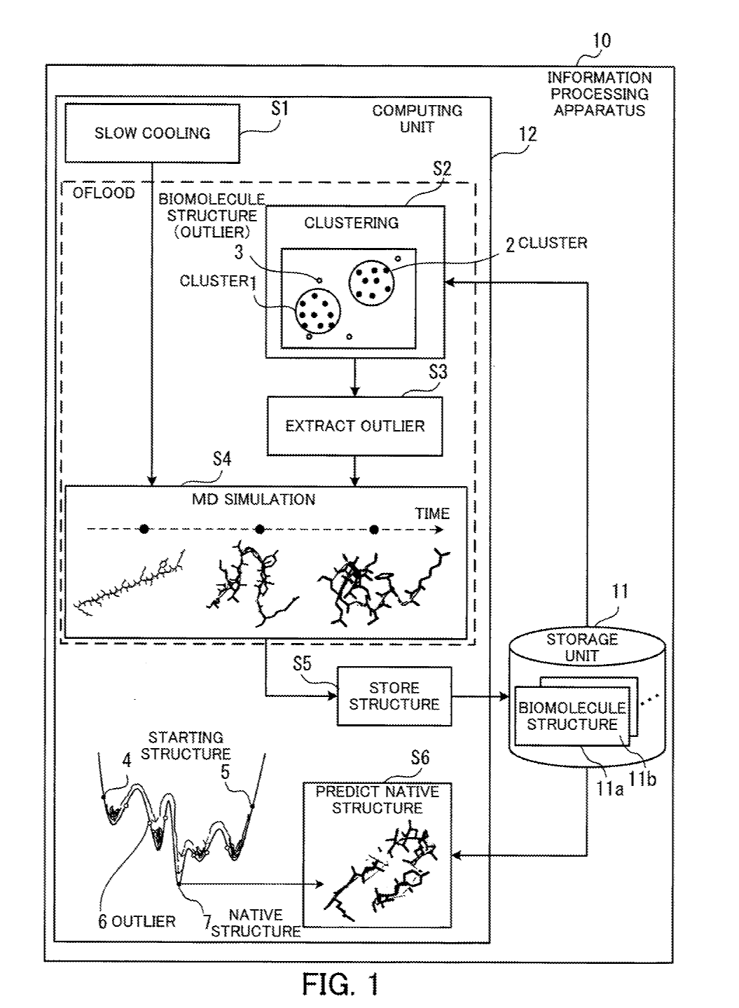

FIG. 1 illustrates an exemplary configuration of an information processing apparatus according to the first embodiment. The information processing apparatus 10 includes a storage unit 11 and a computing unit 12.

The storage unit 11 stores a collection of structures of biomolecules (biomolecule structures 11a, 11b, . . . ) whose structure varies. For example, for the biomolecule structures 11a, 11b, . . . included in the collection, atomic coordinates for atoms forming a material are defined.

The computing unit 12 predicts the native structure of biomolecules whose structure varies. For example, the computing unit 12 employs both SA and OFLOOD to predict the native structure. When a certain solution is obtained, SA randomly selects a neighboring solution within a range corresponding to the temperature of this time. However, the first embodiment employs OFLOOD, instead of randomly selecting a solution.

More specifically, the computing unit 12 performs a slow cooling process in the SA phase (step S1). That is, the computing unit 12 decreases a temperature set as a temperature parameter, which represents the temperature of a material, from a prescribed value (initial value) in steps.

When the temperature parameter is set to a value, the computing unit 12 performs the following process.

First, the computing unit 12 performs clustering on a plurality of biomolecule structures stored in the storage unit 11 (step S2). The clustering technique used here allows the existence of elements that do not belong to any cluster. Through the clustering of the biomolecule structures, clusters 1 and 2 each including a collection of biomolecule structures determined to be similar on the basis of prescribed indexes are produced.

Then, the computing unit 12 extracts a biomolecule structure 3 that does not belong to either the produced cluster 1 or 2, as an outlier, from the clustering result (step S3). If a plurality of biomolecule structures (outliers) that do not belong to either the cluster 1 or 2, the computing unit 12 extracts a predetermined number of biomolecule structures from them as outliers.

Then, the computing unit 12 carries out molecular dynamics (MD) simulations using the temperature parameter, with the outliers, which are the extracted biomolecule structures, as initial structures (step S4). For example, in the MD simulations, the computing unit 12 gives an initial structure an initial speed (kinetic energy) corresponding to the temperature indicated by the temperature parameter to simulate how the structure varies. The MD simulations produce a trajectory that represents transitions in the biomolecule structure. A process from steps S2 to S4 is called OFLOOD.

Then, the computing unit 12 stores biomolecule structures generated by the MD simulations, in the storage unit 11 (step S5). For example, the computing unit 12 stores a plurality of biomolecule structures that form a produced trajectory in the storage unit 11. Thereby, the biomolecule structures forming the newly produced trajectory are included in the collection of biomolecule structures that are to be subjected to the clustering after the next iteration of the slow cooling process.

Steps S2 to S5 are executed for each value of the temperature parameter of the slow cooling process performed in the SA phase. When the value of the temperature parameter has reached a prescribed target temperature, the slow cooling process is terminated. Then, the computing unit 12 predicts the native structure of the biomolecules on the basis of the plurality of biomolecule structures 11a, 11b, . . . , stored in the storage unit 11 (step S6). For example, the computing unit 12 predicts a biomolecule structure with a small energy among the biomolecule structures 11a, 11b, . . . stored in the storage unit 11, as the native structure of the biomolecules.

As described above, each time the temperature is decreased in the slow cooling process in the SA phase, the above information processing apparatus 10 performs clustering on biomolecule structures generated up to this time point to detect biomolecule structures that are outliers, and then performs MD simulations using the detected biomolecule structures as initial structures. To use outliers as initial structures for the MD simulations prevents a solution search range from being trapped into a local optimal solution. As a result, it is possible to detect the native structure 7 of biomolecules efficiently.

For example, two biomolecule structures for use as starting structures 4 and 5 are prepared. MD simulations are carried out starting from these two starting structures, thereby reproducing transitions from the starting structures to a stable structure. Each biomolecule structure generated during the structural transitions is stored in the storage unit 11. When the temperature is decreased in the slow cooling process after that, the clustering is performed on the biomolecule structures generated up to this time point, and biomolecule structures 3 are detected as outliers. The biomolecule structures 3 detected as outliers in the clustering are greatly different from many structures belonging to the clusters 1 and 2. Therefore, for example, in the case of searching for a biomolecule structure with a low energy, structures that are greatly different from the structures of local optimal solutions are extracted as outliers 6. By selecting such outliers 6 and then performing the MD simulations repeatedly at each iteration of the slow cooling process, the search range is converged to reach the native structure 7 efficiently.

In this connection, the computing unit 12 may be implemented by a processor provided in the information processing apparatus 10, for example. In addition, the storage unit 11 may be implemented by a memory provided in the information processing apparatus 10, for example.

In addition, lines connecting the components illustrated in FIG. 1 are a part of communication paths, and other communication paths than illustrated may be configured.

### Second Embodiment

The following describes a second embodiment. The second embodiment describes a more concrete example of the technique of the first embodiment, using a protein for the structure analysis. That is to say, the second embodiment relates to a protein native structure prediction simulation technique using a computer.

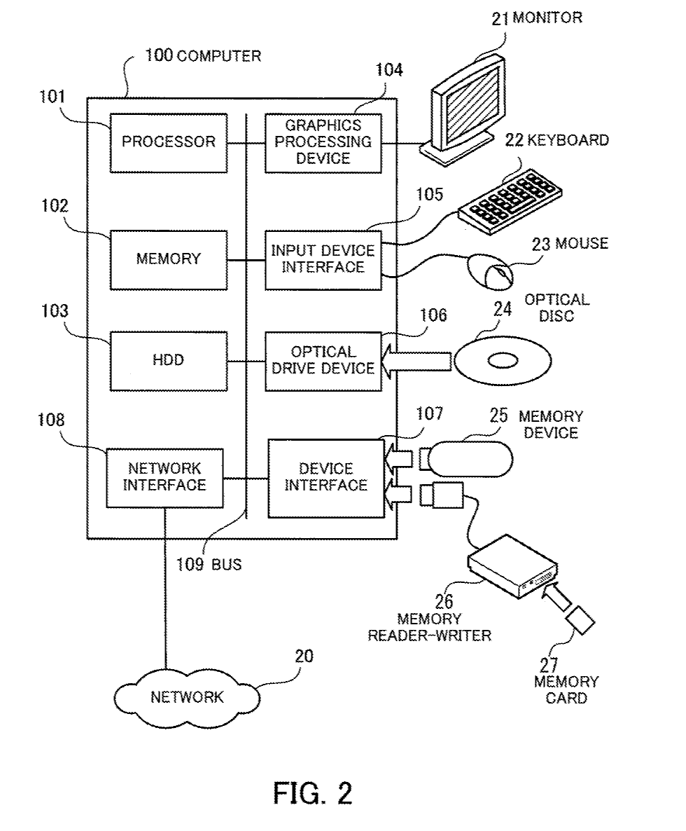

FIG. 2 illustrates an exemplary hardware configuration of a computer according to the second embodiment. The computer 100 is entirely controlled by a processor 101. A memory 102 and a plurality of peripheral devices are connected to the processor 101 via a bus 109. The processor 101 may be a multiprocessor. The processor 101 is, for example, a Central Processing Unit (CPU), a Micro Processing Unit (MPU), or a Digital Signal Processor (DSP). At least part of functions implemented by the processor 101 executing a program may be implemented by using an Application Specific Integrated Circuit (ASIC), a Programmable Logic Device (PLD), or other electronic circuits.

The memory 102 is used as a main storage device of the computer 100. The memory 102 temporarily stores therein at least part of Operating System (OS) programs and application programs to be executed by the processor 101. Also, the memory 102 stores therein a variety of data that is used by the processor 101 in processing. As the memory 102, a volatile semiconductor storage device, such as a Random Access Memory (RAM), may be used, for example.

The peripheral devices connected to the bus 109 include a Hard Disk Drive (HDD) 103, a graphics processing device 104, an input device interface 105, an optical drive device 106, a device interface 107, and a network interface 108.

The HDD 103 magnetically reads and writes data on a built-in disk. The HDD 103 is used as an auxiliary storage device of the computer 100. The HDD 103 stores OS programs, application programs, and a variety of data. In this connection, as the auxiliary storage device, a flash memory or another non-volatile semiconductor device (Solid State Drive “SSD”) may be used.

A monitor 21 is connected to the graphics processing device 104. The graphics processing device 104 displays images on the display of the monitor 21 in accordance with instructions from the processor 101. As the monitor 21, a display device using a Cathode Ray Tube (CRT) display or liquid crystal display device may be used.

A keyboard 22 and a mouse 23 are connected to the input device interface 105. The input device interface 105 outputs signals received from the keyboard 22 and mouse 23 to the processor 101. In this connection, the mouse 23 is one example of pointing devices, and another pointing device may be used. Other pointing devices include touch panels, tablets, touch pads, and trackballs.

The optical drive device 106 reads data from an optical disc 24 with laser light or the like. The optical disc 24 is a portable recording medium on which data is recorded such as to be readable with reflection of light. The optical disc 24 may be a Digital Versatile Disc (DVD), DVD-RAM, CD-ROM (Compact Disc Read Only Memory), CD-R (Recordable), CD-RW (ReWritable), or another.

The device interface 107 is a communication interface that allows peripheral devices to be connected to the computer 100. For example, a memory device 25 or memory reader-writer 26 may be connected to the device interface 107. The memory device 25 is a recording medium having a function of communicating with the device interface 107. The memory reader-writer 26 reads or writes data on a memory card 27, which is a card-type recording medium.

The network interface 108 is connected to the network 20. The network interface 108 communicates data with another computer or communication device over the network 20.

With the above hardware configuration, the processing functions of the second embodiment are implemented. In this connection, the information processing apparatus 10 of the first embodiment may be implemented with the same hardware configuration as the computer 100 of FIG. 2.

The computer 100 implements the processing functions of the second embodiment by executing a program recorded on a computer-readable recording medium, for example. The program describing the processing content to be executed by the computer 100 may be recorded on a variety of recording media. For example, the program to be executed by the computer 100 may be stored on the HDD 103. The processor 101 loads at least part of the program from the HDD 103 to the memory 102 and then executes the program. Alternatively, the program to be executed by the computer 100 may be recorded on the optical disc 24, memory device 25, memory card 27, or another portable recording medium. The program stored in such a portable recording medium becomes executable after being installed on the HDD 103 under the control of the processor 101, for example. Alternatively, the processor 101 may execute the program directly read from a portable recording medium.

The computer 100 with the above hardware configuration is able to carry out protein native structure prediction simulations. The functions that implement the protein native structure prediction simulations may be represented as a plurality of functional blocks.

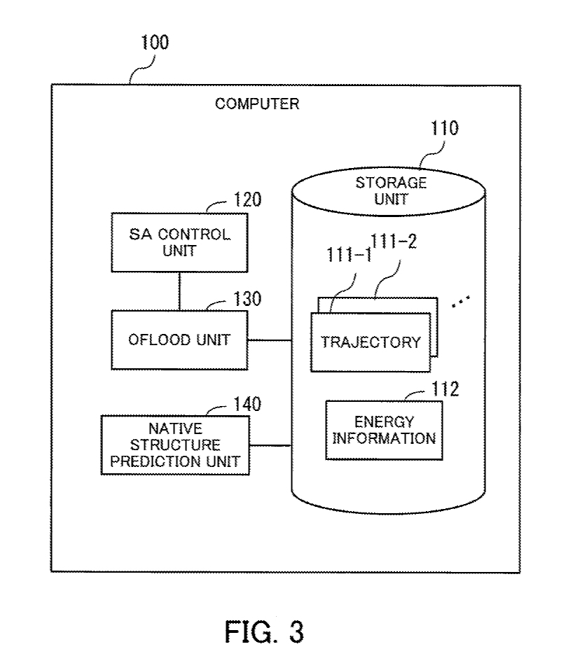

FIG. 3 is a functional block diagram for protein native structure prediction simulations. The computer 100 includes a storage unit 110, an SA control unit 120, an OFLOOD unit 130, and a native structure prediction unit 140 for carrying out protein native structure prediction simulations.

The storage unit 110 stores therein trajectories 111-1, 111-2, . . . produced by protein native structure prediction simulations, and energy information 112. Each trajectory 111-1, 111-2, . . . is data representing time-series transitions of a protein structure, and includes a plurality of protein structures corresponding to the time series. The energy information 112 is about the energy of each protein structure included in the trajectories 111-1, 111-2, . . . .

The SA control unit 120 controls a slow cooling process in an SA phase. For example, the SA control unit 120 decreases the temperature from 400K (absolute temperature) to 300K slowly in steps of 10K.

The OFLOOD unit 130 carries out simulations using OFLOOD at each temperature of the SA phase. The OFLOOD unit 130 stores trajectories produced by the simulations in the storage unit 110. Also, each time a trajectory is produced, the OFLOOD unit 130 calculates the energy of each protein structure included in the trajectory, and then registers the energy value of each protein structure in the energy information 112.

The native structure prediction unit 140 specifies a protein structure regarded as being closest to the protein native structure among the protein structures included in the trajectories 111-1, 111-2, . . . . For example, the native structure prediction unit 140 specifies a protein structure with the smallest energy, as the native structure. Then, the native structure prediction unit 140 outputs the specified protein structure as the protein native structure.

In this connection, lines connecting the components illustrated in FIG. 3 are a part of communication paths, and other communication paths than illustrated may be configured. In addition, the functions of each component illustrated in FIG. 3 may be implemented by causing the computer 100 to execute a program module corresponding to the component.

The following describes information stored in the storage unit 110 in detail.

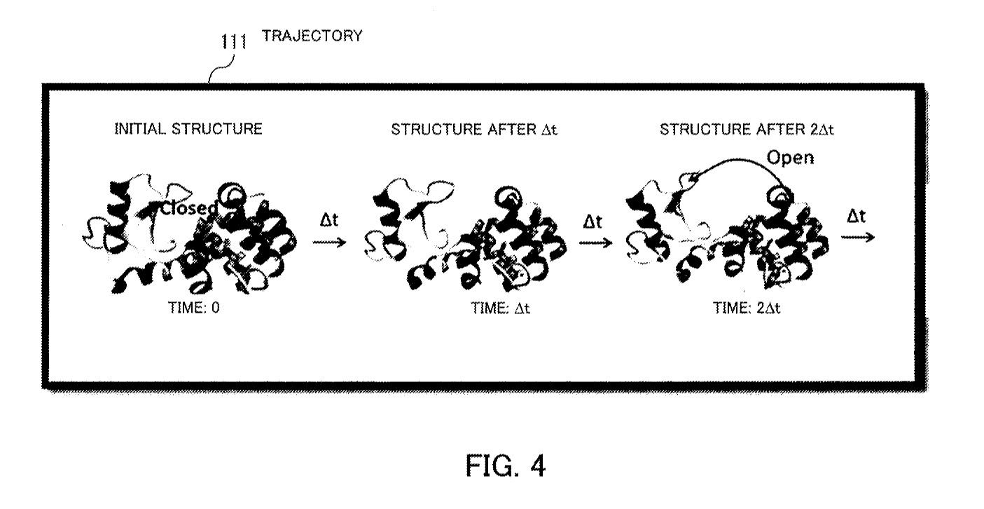

FIG. 4 illustrates an example of a trajectory. A trajectory 111 represents how a protein transitions from an initial structure. These transitions are reproduced by MD simulations, for example. FIG. 4 depicts structures obtained at time intervals Δt by the MD simulations, by way of example. The protein structures included in the trajectory 111 are represented as structure data including the coordinates of atoms forming the protein, for example.

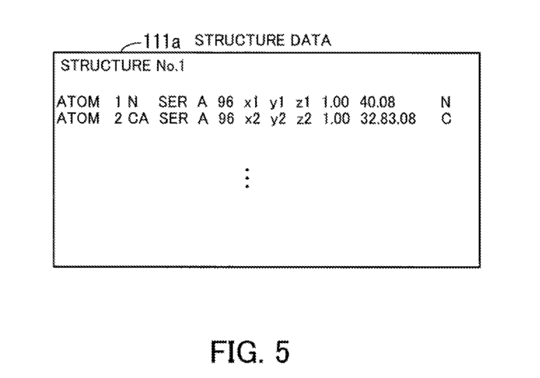

FIG. 5 illustrates an example of structure data of a protein. A structure identification number is given to structure data 111a. Each row starting with “ATOM” in the structure data 111a describes information about each atom included in the protein.

On each row, there are the following items, starting with “ATOM” to the right: atom's serial number; class of atom type; residue type; molecular chain name; residue number; atom's X coordinate; atom's Y coordinate; atom's Z coordinate; atom occupation ratio; temperature factor; and element name.

In addition, the energy of each protein structure included in the trajectories 111-1, 111-2, . . . is registered in association with the structure data of the protein structure in the energy information 112.

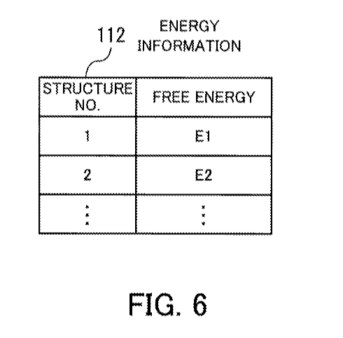

FIG. 6 illustrates an example of energy information. Referring to the example of FIG. 6, the energy of a protein structure is set in association with a structure number given to the structure data of the protein structure. A protein structure with a smaller energy value is considered to be closer to the native structure.

A protein native structure prediction process is performed using information illustrated in FIGS. 4 to 6. In the protein native structure prediction process of the second embodiment, the OFLOOD unit 130 efficiently searches for an optimal solution (the native structure of a protein) by resetting the initial structure to be subjected to MD simulations at each iteration of a slow cooling process in an SA phase.

For example, when resetting the initial structure, the OFLOOD unit 130 performs clustering on protein states (individual protein structures) with a clustering algorithm called FlexDice in a high-dimensional structure space. FlexDice allows the existence of protein structures that do not belong to any cluster generated by the clustering. Therefore, the OFLOOD unit 130 detects protein structures that do not belong to any cluster as outliers, from the result of FlexDice.

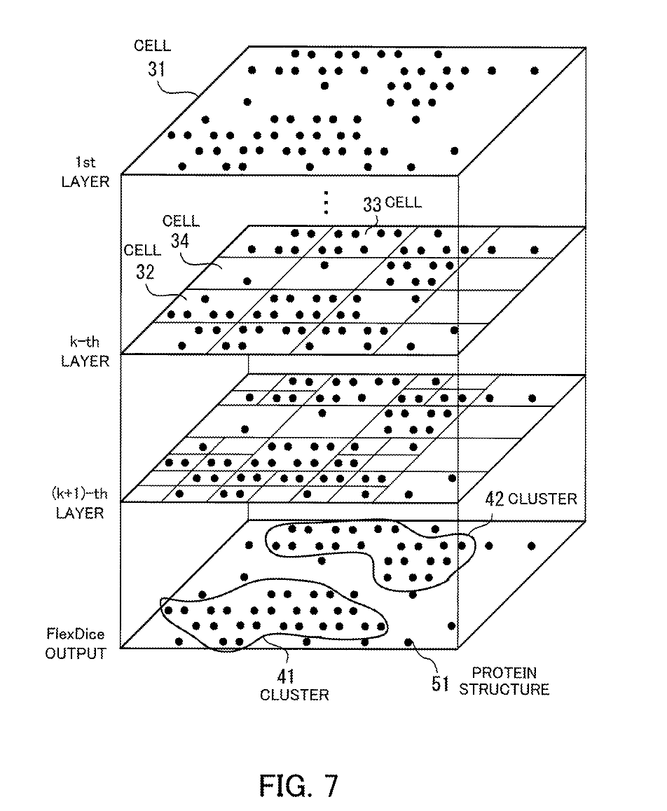

FIG. 7 illustrates an example of a clustering algorithm FlexDice. FlexDice is one of clustering algorithms for finding rules or characteristics from a high-dimensional and large-scale database. In FlexDice, data elements are plotted in a multi-dimensional space that uses indexes for classifying data elements as axes. In the case where protein structures are used as data elements, for example, the indexes for classification may be the coordinates of specified atoms on a certain axis, a distance between two prescribed atoms, or others. FIG. 7 illustrates an example where the classification is performed with two indexes.

In FlexDice, a plane having two axes respectively corresponding to two indexes is defined. All protein structures are plotted on the first-layer plane on the basis of their index values. In the first layer, one rectangular area including all protein structures is defined as a cell 31.

A higher-ranked layer cell is divided according to the density of protein structures within the cell. Thereby, new layers are sequentially generated, like a second layer, a third layer, . . . . For example, if the density of protein structures within a cell is greater than or equal to an upper limit, the cell is taken as a dense cell. If the density of protein structures within a cell is smaller than the upper limit and greater than or equal to a lower limit, the cell is taken as a medium cell. If the density of protein structures within a cell is smaller than the lower limit, the cell is taken as a sparse cell. In generating a lower-ranked layer from a higher-ranked layer, only medium cells among the cells of the higher-ranked layer are each divided into two in each axis direction (divided into four in total). For example, a cell 32 of the k-th layer (k is an integer of two or greater) is determined as a medium cell, and is divided into four cells in the (k+1)-th layer. A cell 33 is not divided because this cell 33 is a dense cell. A cell 34 is not divided because this cell 34 is a sparse cell.

Such generation of layers is repeated until a predetermined layer is generated. In the last layer, dense cells adjacent to each other are combined. Collections of protein structures included in the combined cells form clusters 41 and 42.

In the above clustering algorithm FlexDice, a protein structure 51 that does not belong to either cluster 41 or 42 exists and is detected as an outlier.

The OFLOOD unit 130 uses detected outliers as initial structures for MD simulations. Outliers in a high-dimensional structure space are likely to correspond to transitional structures of the protein. Therefore, it is considered that resetting a traced structure to an outlier at any time in the annealing phase makes it possible to promote structural transitions to reach an optimal solution, and therefore contributes to achieve an efficient structure search.

The following describes a protein native structure prediction process in the second embodiment, in detail.

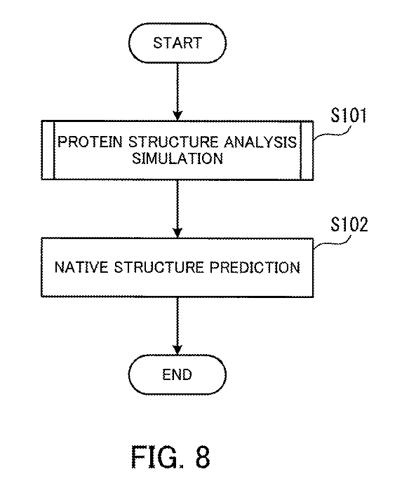

FIG. 8 illustrates an example of a protein native structure prediction process.

(Step S101) The SA control unit 120 and the OFLOOD unit 130 cooperate with each other to perform a protein structure analysis simulation that is a combination of SA and OFLOOD.

In the annealing phase (a slow cooling process), the temperature for carrying out MD simulations is set to “Tₙ, Tₙ₋₁, . . . , T₀” (n is an integer of one or greater). In this connection, Tₙ>Tₙ₋₁> . . . >T₀. The SA control unit 120 sets the initial value of the temperature to Tₙ for the simulations, and then slowly decreases the temperature down to T₀ (target temperature) in steps.

The OFLOOD unit 130 performs a protein structure search at each temperature. In this second embodiment, not a random search for a neighboring solution or a simple structure search using MD simulations, but OFLOOD is executed. OFLOOD drastically improves the efficiency of the protein structure search.

For example, the OFLOOD unit 130 performs a structure search with OFLOOD at the temperature Tₙ indicated by the temperature parameter used in the SA phase. In this structure search, for example, M steps (M is an integer of one or greater) are executed. Then, the OFLOOD unit 130 executes OFLOOD (M steps) at the temperature of Tₙ₋₁. Then, the OFLOOD unit 130 executes OFLOOD each time the temperature is decreased, and finally executes OFLOOD (M steps) at the temperature of T₀.

By executing OFLOOD at each prescribed temperature in the annealing phase, a plurality of trajectories are produced and stored in the storage unit 110.

(Step S102) The native structure prediction unit 140 predicts the native structure of the protein. For example, the native structure prediction unit 140 takes a structure with the most stable energy, among structures generated up to when the temperature is finally decreased to T₀, as a candidate structure that is close to the native structure. In addition, the native structure prediction unit 140 may perform clustering on protein structures with FlexDice and analyze the stable structure of the protein. In this case, for example, the native structure prediction unit 140 proposes a protein structure with a high occurrence probability as a candidate native structure. Alternatively, the native structure prediction unit 140 may identify a final native structure, considering the potential energy of each protein structure obtained by MD simulations in addition to a result of the clustering algorithm FlexDice.

The following describes a protein structure analysis simulation in detail.

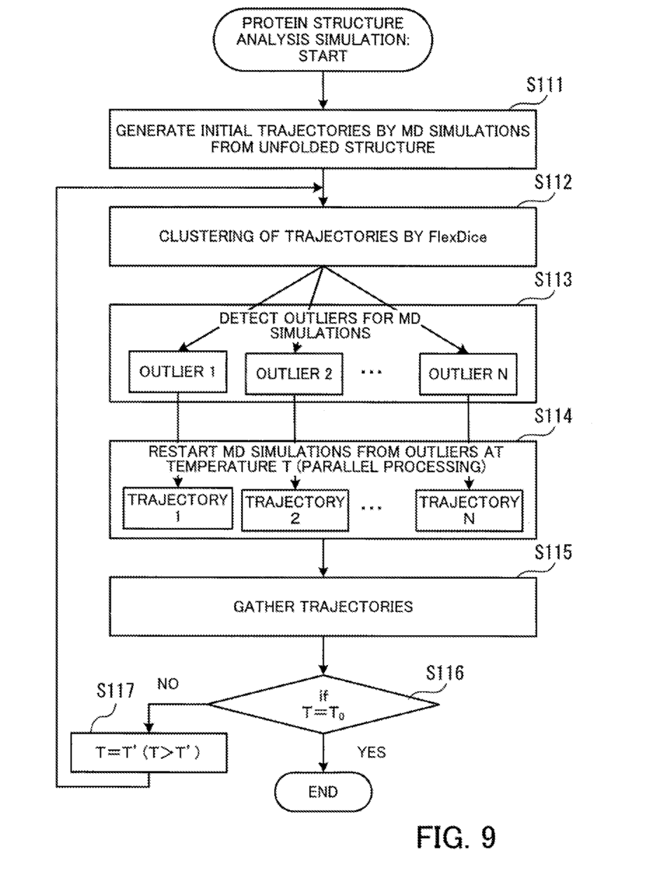

FIG. 9 is a flowchart depicting an example of a protein structure analysis simulation. The process of FIG. 9 will be described step by step.

(Step S111) The SA control unit 120 sets the temperature T to the initial value Tₙ for the simulation. Then, the OFLOOD unit 130 carries out MD simulations using a certain unfolded structure as an initial structure to thereby generate initial trajectories.

(Step S112) The OFLOOD unit 130 performs clustering on the trajectories with FlexDice. For example, the OFLOOD unit 130 performs the clustering algorithm FlexDice using the structure data indicating the protein structures of all trajectories stored in the storage unit 110 as data elements to be subjected to the clustering.

(Step S113) The OFLOOD unit 130 extracts outliers from the result of the clustering algorithm FlexDice, and arranges them as initial structures for MD simulations. To arrange the outliers means registering the structure data representing the protein structures corresponding to the outliers, as the initial structures for the MD simulations in the memory.

Many outliers may be obtained as a result of clustering. In this case, the OFLOOD unit 130 selects a predetermined number of outliers and arranges them as the initial structures for the MD simulations. Outliers are selected randomly, for example. Outliers may be selected in order from an outlier that is a protein structure with the smallest energy. Referring to the example of FIG. 9, N outliers (N is an integer of one or greater) are selected and arranged as initial structures for the MD simulations.

(Step S114) The OFLOOD unit 130 restarts the MD simulations at the temperature T, using the outliers as initial structures. It is possible to carry out the MD simulations for individual outliers independently. Therefore, the OFLOOD unit 130 may use different processors to carry out the MD simulations of the individual outliers in parallel. The parallel execution of the MD simulations achieves efficient processing. A trajectory for each outlier is produced by the MD simulations of the outlier.

In this connection, each time a new protein structure is generated in the course of the MD simulations, the OFLOOD unit 130 may calculate the energy of the protein structure.

(Step S115) The OFLOOD unit 130 gathers the produced trajectories. For example, the OFLOOD unit 130 stores the trajectory produced for each outlier in the storage unit 110. In addition, in the case of calculating the energy of a protein structure included in a trajectory, the OFLOOD unit 130 registers the energy value in the energy information 112 in association with the protein structure.

A process from step S112 to step S115 is called OFLOOD.

(Step S116) The SA control unit 120 determines whether the temperature T has reached a target temperature T₀, which is the preset end point of the annealing. When the temperature T is equal to the target temperature T₀, the protein structure analysis simulation ends. When the temperature T is higher than the target temperature T₀, the process proceeds to step S117.

(Step S117) The SA control unit 120 decreases the temperature T to T′ (T>T′) for slow cooling. That is, the SA control unit 120 sets the parameter representing the temperature T to T′. For example, T′ is a value obtained by subtracting a prescribed temperature difference ΔT from T. Then, the process proceeds to step S112 where OFLOOD is repeated at the decreased temperature.

As illustrated in FIG. 9, the protein structure analysis using OFLOOD does not erroneously take a local optimal solution as a correct structure but results in detecting the correct native structure of a protein, without the need of making the cooling speed very slow in the SA phase. This is because OFLOOD achieves an efficient structure search in the slow cooling process.

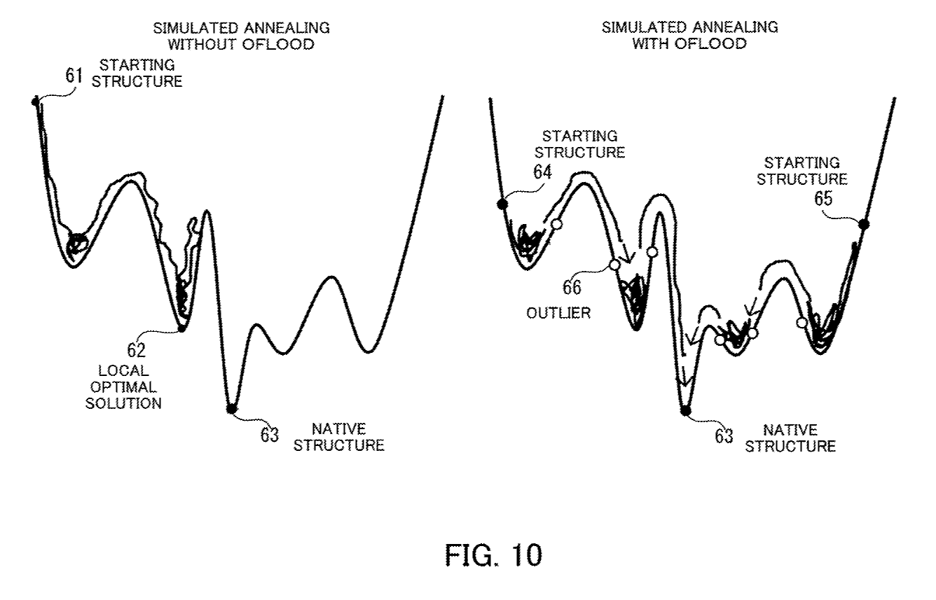

FIG. 10 is a conceptual diagram depicting a difference between protein structure search processes with and without OFLOOD. FIG. 10 illustrates on the left side a protein structure search process performed by SA without OFLOOD. FIG. 10 illustrates on the right side a protein structure search process performed by SA with OFLOOD. The horizontal axis in FIG. 10 represents variations in a protein structure. The positions of structures farther away from each other on the horizontal axis mean a bigger difference between the structures. The vertical axis in FIG. 10 represents the energy of protein structures. A curve in FIG. 10 represents energy values corresponding to protein structures. A lower position in the curve indicates a protein structure with a smaller energy. A line on the curve indicating energy represents a track of searching for a protein structure by SA.

In the case of SA without OFLOOD, a structure search is performed in a direction from the protein structure (starting structure 61) of the start of the simulation toward a protein structure with a smaller energy. Since the protein structure greatly varies in the MD simulations when the annealing temperature is high, the search may be performed in a direction toward a higher energy. However, the search in a direction toward a higher energy is hardly to be performed as the temperature is decreased, and the search is possibly stuck in the vicinity of a local optimal solution 62. In this case, the search fails to reach the native structure 63 (optimal structure) with the smallest energy, and erroneously outputs the local optimal solution 62 as a correct structure.

In SA with OFLOOD as illustrated in FIG. 10, the analysis is conducted starting with two starting structures 64 and 65. Using the plurality of starting structures 64 and 65 increases a possibility of reaching the native structure. In addition, OFLOOD is executed in the slow cooling process in the annealing phase, so that MD simulations are carried out with protein structures that are outliers as initial structures. Such outliers have big different structures from protein structures that have been generated. Therefore, the search range is not converged to the vicinity of a local optimal solution. Therefore, to repeat the structure resampling through OFLOOD makes it possible to conduct a structure search in a wider range, without trapping it into a local optimal solution, which results in reaching an optimal solution (native structure 63).

In addition to this, the approach of the second embodiment makes it possible to find the native structure of a protein efficiently. As an example, a protein native structure prediction process was performed by conducting a test calculation on a 20-residue protein Trp-cage (Protein Data Bank (PDB) id:1L2Y), starting from an unfolded structure as “blind prediction”. The “blind prediction” does not use any information about native structures at all. As a result, the native structure was predicted with an accuracy where the Root Mean Square Deviation (RMSD) from the most stable structure was within 1.0 angstrom. As is seen from this test calculation, it may be expected that the protein native structure prediction process of the second embodiment is applicable to large-scale protein native structure prediction.

In this connection, in the Trp-cage test calculation, the temperature was decreased from 400K to 300K slowly in steps of 10K in the annealing phase. In addition, 100 outliers (100 outliers were randomly selected in the case where 100 or more outliers were detected) were detected per cycle of OFLOOD, and short-time (100 ps) MD simulations were carried out with these outliers as initial structures. The calculation cost per cycle of OFLOOD is calculated as 100×100 ps=10 ns. For comparison, a protein native structure prediction process by SA without OFLOOD was performed at the same calculation cost.

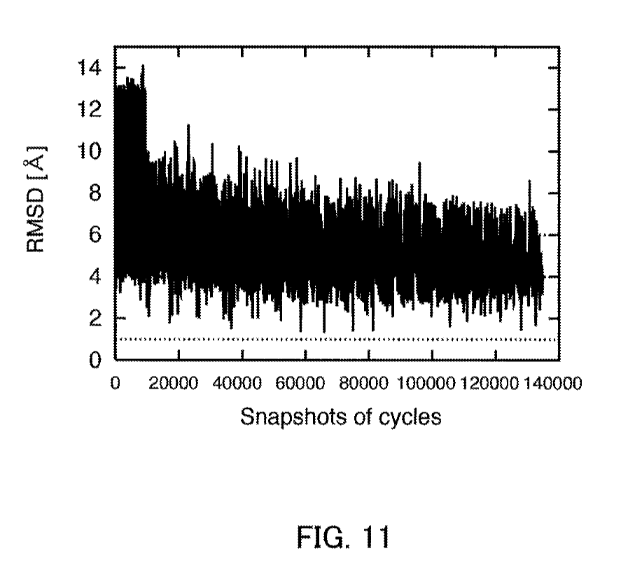

FIG. 11 illustrates an example of a test calculation of an artificial protein Trp-cage by SA without OFLOOD. In SA without OFLOOD, a protein structure is searched for by MD simulations in the slow cooling process. However, it is difficult to reach the most stable structure (native structure) because the search is trapped into a local stable structure. In FIG. 11, the horizontal axis represents the number of calculations for a protein structure, whereas the vertical axis represents the RMSD derived from the native structure of the generated protein structure. RMSD is the square root of the mean of the squares of differences between atom positions of two superimposed molecule structures. A smaller RMSD indicates a more similarity between two molecule structures.

In addition, a dotted line in FIG. 11 indicates a position where the RMSD from native structure is 1.0 angstrom. In general, if a protein structure is detected with an accuracy where the RMSD from native structure is 1.0 angstrom or less, it is evaluated that the detected protein structure is a correct native structure. The example of FIG. 11 indicates that a range where protein structures with RMSD of 1.0 angstrom or less existed was not searched and the range was not converged to reach the native structure.

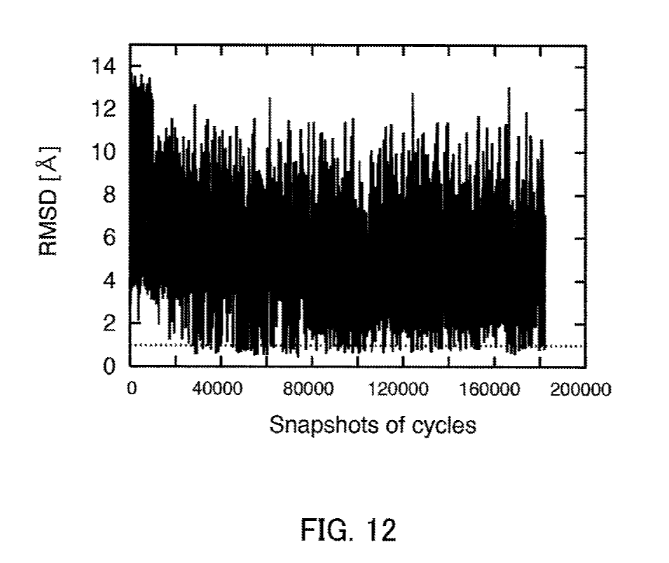

FIG. 12 illustrates an example of a test calculation of an artificial protein Trp-cage by SA with OFLOOD. SA in which structure resampling (extraction of outliers) is conducted with OFLOOD, instead of MD simulations, in the slow cooling process makes it possible to reach the native structure efficiently. For example, it is recognized that a range where RMSD from native structure, indicated by dotted line, was 1.0 angstrom or less was searched and that it was possible to predict the native structure with a high accuracy. In addition, in the example of FIG. 12, a range where structures with RMSD of 1.0 angstrom or less was searched from very early stage, and it is possible to find a structure extremely close to the native structure immediately. This means achieving a smaller amount of processing to predict the native structure.

As described above, the second embodiment makes it possible to achieve an efficient structure search from the primary sequence of amino acids, which determines the protein native structure. Therefore, it is possible to predict the native structure. This technique is applicable in many fields. More specifically, the structure prediction makes it possible to efficiently predict/design crystal structures of materials in the fields of industrials.

According to one aspect, it is possible to predict the native structure of biomolecules efficiently.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to store a collection of structures of biomolecules whose structure varies; and
a processor configured to perform a procedure including:
decreasing a temperature set as a temperature parameter from a prescribed value in steps, the temperature parameter representing a temperature of the biomolecules;
performing, upon decreasing the temperature of the temperature parameter, clustering on the structures included in the collection from before the decreasing of the temperature, detecting an outlier structure from a result of the clustering, and performing a molecule dynamics simulation using the temperature parameter with the outlier structure as an initial structure; and
including a structure generated by the molecule dynamics simulation in the collection.

2. The information processing apparatus according to claim 1, wherein the procedure further includes predicting a native structure of the biomolecules based on the structures included in the collection.

3. The information processing apparatus according to claim 1, wherein:
the processor is provided in plurality; and
at least one of the processors extracts a plurality of structures that do not belong to any cluster produced by the clustering as outlier structures, and the processors respectively performs molecule dynamics simulations with the extracted outlier structures as initial structures in parallel.

4. A simulation method comprising:
decreasing, by a processor, a temperature set as a temperature parameter from a prescribed value in steps, the temperature parameter representing a temperature of biomolecules whose structure varies;
performing, by the processor, upon decreasing the temperature of the temperature parameter, clustering on structures included in a collection of structures of the biomolecules from before the decreasing of the temperature, detecting an outlier structure from a result of the clustering, and performing a molecule dynamics simulation using the temperature parameter with the outlier structure as an initial structure; and
including, by the processor, a structure generated by the molecule dynamics simulation in the collection.

5. A non-transitory computer-readable storage medium storing a computer program that causes a computer to perform a procedure comprising:
decreasing a temperature set as a temperature parameter from a prescribed value in steps, the temperature parameter representing a temperature of biomolecules whose structure varies;
performing, upon decreasing the temperature of the temperature parameter, clustering on structures included in a collection of structures of the biomolecules from before the decreasing of the temperature, detecting an outlier structure from a result of the clustering, and performing a molecule dynamics simulation using the temperature parameter with the outlier structure as an initial structure; and
including a structure generated by the molecule dynamics simulation in the collection.
